(19) United States
(12) Patent Application Publication
(10) Pub. No.: US 2025/0150889 A1
(43) Pub. Date: May 8, 2025

(54) QUALITY OF SERVICE-BASED PEER-TO-PEER TRANSMISSION OPPORTUNITY GRANTS

(71) Applicant: QUALCOMM Incorporated, San Diego, CA (US)

(72) Inventors: George CHERIAN, San Diego, CA (US); Xiaolong HUANG, Santee, CA (US); Sai Yiu Duncan HO, San Diego, CA (US); Alfred ASTERJADHI, San Diego, CA (US); Abhishek Pramod PATIL, San Diego, CA (US); Gaurang NAIK, San Diego, CA (US); Srinivas KATAR, Fremont, CA (US)

(21) Appl. No.: 18/503,134

(22) Filed: Nov. 6, 2023

(51) Int. Cl. H04W 28/02; H04W 72/543; H04W 84/12

(52) U.S. Cl. CPC H04W 28/0268; H04W 72/543; H04W 84/12

(57) ABSTRACT

This disclosure provides methods, components, devices and systems for quality of service (QOS) based peer-to-peer (P2P) transmission opportunity grants. A first wireless communication device receives a first management message including a first stream identifier associated with a second wireless communication device. The first wireless communication device transmits a second management message to an access point, the second management message including a second stream identifier and an identifier of the second wireless communication device based on the first management message. The first wireless communication device receives a first control message associated with a shared transmission opportunity, the first control message including parameters that satisfy a set of QoS of the second wireless communication device, where the first control message enables the shared transmission opportunity for the second wireless communication device and a third wireless communication device.

### TECHNICAL FIELD

This disclosure relates to wireless communication and, more specifically, to quality of service-based peer-to-peer transmission opportunity grants. An access point allocating resources for transmission opportunity grants may receive an indication of identifiers associated with one or more end client devices in order to provide transmission opportunity grants in accordance with parameters associated with end flow.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, wireless communication devices may communicate directly, such as in a peer-to-peer (P2P) communication. A first AP may allocate, to a second AP, resources for a transmission opportunity (TXOP) sharing. The second AP may provide a TXOP grant for sharing to a first wireless communication device, in which the second AP may participate in the P2P communication with the first wireless communication device. However, the first AP, which allocates the resources, may be unaware or may not have knowledge of communication parameters, such as quality of service parameters, that are associated with the first wireless communication device participating in the P2P communication. For example, the first AP that allocates resources for the TXOP may not have knowledge of the end client using the TXOP.

### SUMMARY

The systems, methods, and devices of this disclosure each have several innovative aspects, no single one of which is solely responsible for the desirable attributes disclosed herein.

A method by a first wireless communication device is described. The method may include one or more memories storing processor-executable code, one or more processors communicatively coupling with the one or more memories and individually or collectively configured to, when executing the code, cause first wireless communication device to, receiving a first management message including a first stream identifier associated with a second wireless communication device, transmitting a second management message to an access point, the second management message including a second stream identifier and an identifier of the second wireless communication device based on the first management message, and receiving a first control message associated with a shared transmission opportunity (TXOP), the first control message including one or more parameters that satisfy a set of quality of service parameters of the second wireless communication device, where the first control message enables the shared TXOP for the second wireless communication device and a third wireless communication device.

A first wireless communication device is described. The first wireless communication device may include a processing system that includes processor circuitry and memory circuitry that stores code. The processing system may be configured to cause the first wireless communication device to one or more memories storing processor-executable code, one or more processors communicatively coupled with the one or more memories and individually or collectively configured to, when executing the code, cause first wireless communication device to, receive a first management message including a first stream identifier associated with a second wireless communication device, transmit a second management message to an access point, the second management message including a second stream identifier and an identifier of the second wireless communication device based on the first management message, and receive a first control message associated with a shared TXOP, the first control message including one or more parameters that satisfy a set of quality of service parameters of the second wireless communication device, where the first control message enables the shared TXOP for the second wireless communication device and a third wireless communication device.

Another first wireless communication device is described. The first wireless communication device may include means for one or more memories storing processor-executable code, means for one or more processors communicatively coupling with the one or more memories and individually or collectively configured to, when executing the code, cause first wireless communication device to, means for receiving a first management message including a first stream identifier associated with a second wireless communication device, means for transmitting a second management message to an access point, the second management message including a second stream identifier and an identifier of the second wireless communication device based on the first management message, and means for receiving a first control message associated with a shared TXOP, the first control message including one or more parameters that satisfy a set of quality of service parameters of the second wireless communication device, where the first control message enables the shared TXOP for the second wireless communication device and a third wireless communication device.

A non-transitory computer-readable medium storing code is described. The code may include instructions executable by a processor to one or more memories storing processor-executable code, one or more processors communicatively coupled with the one or more memories and individually or collectively configured to, when executing the code, cause first wireless communication device to, receive a first management message including a first stream identifier associated with a second wireless communication device, transmit a second management message to an access point, the second management message including a second stream identifier and an identifier of the second wireless communication device based on the first management message, and receive a first control message associated with a shared TXOP, the first control message including one or more parameters that satisfy a set of quality of service parameters of the second wireless communication device, where the first control message enables the shared TXOP for the second wireless communication device and a third wireless communication device.

In some examples of the method, first wireless communication devices, and non-transitory computer-readable medium described herein, the third wireless communication device may be co-located with the first wireless communication device.

Some examples of the method, first wireless communication devices, and non-transitory computer-readable medium described herein may further include operations, features, means, or instructions for generating the second stream identifier such that the second stream identifier corresponds to the first stream identifier, where a quantity of bits of the second stream identifier may be smaller than a total quantity of bits of the first stream identifier and the identifier of the second wireless communication device.

In some examples of the method, first wireless communication devices, and non-transitory computer-readable medium described herein, the first control message includes the second stream identifier.

Some examples of the method, first wireless communication devices, and non-transitory computer-readable medium described herein may further include operations, features, means, or instructions for modifying at least one parameter associated with the set of quality of service parameters for the second wireless communication device based on a delay associated with receiving the first control message, where the one or more parameters of the first control message may be based on modifying the at least one parameter.

Some examples of the method, first wireless communication devices, and non-transitory computer-readable medium described herein may further include operations, features, means, or instructions for receiving a third management message including the first stream identifier associated with a fourth wireless communication device, determine a third stream identifier as an identifier for the fourth wireless communication device, where the first stream identifier may be different than the third stream identifier, and transmit a fourth management message to the access point, the fourth management message including the third stream identifier and an identifier of the fourth wireless communication device.

In some examples of the method, first wireless communication devices, and non-transitory computer-readable medium described herein, the first management message and the second management message may be associated with a management encapsulation frame.

In some examples of the method, first wireless communication devices, and non-transitory computer-readable medium described herein, the first management message includes a first stream classification service message and the second management message include a second stream classification service (SCS) message.

In some examples of the method, first wireless communication devices, and non-transitory computer-readable medium described herein, the second stream identifier includes an SCS identifier.

In some examples of the method, first wireless communication devices, and non-transitory computer-readable medium described herein, the second stream identifier includes a traffic identifier (TID).

In some examples of the method, first wireless communication devices, and non-transitory computer-readable medium described herein, the shared TXOP may be associated with peer-to-peer (P2P) communication between the first wireless communication device, the second wireless communication device, the third wireless communication device, or any combination thereof.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example of a signaling diagram that supports quality of service-based peer-to-peer transmission opportunity grants.

FIG. 4 shows an example of a process flow that supports quality of service-based peer-to-peer transmission opportunity grants.

FIG. 5 shows a block diagram of an example wireless communication device that supports quality of service-based peer-to-peer transmission opportunity grants.

FIGS. 6 and 7 show flowcharts illustrating example processes performable by or at a first wireless communication device that supports quality of service-based peer-to-peer transmission opportunity grants.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to techniques for satisfying device-specific quality-of-service (QOS) for shared transmission opportunities (TXOPs), such as for peer-to-peer (P2P) communications using a shared TXOP. In some examples, a first wireless communication device, such as an extended reality (XR) device (such as a virtual reality (VR) headset, an augmented reality (AR) headset, a mixed reality (MR) headset, among other examples) may communicate with a second wireless communication device, such as another XR headset, via P2P communication. Another wireless communication device (such as an access point (AP) or similar device, a relay wireless communication device, a software-enabled AP (soft AP), among other examples) may provide the TXOP to one of the wireless communication devices, such as the first wireless communication device or the second wireless communication device. In some examples, the AP also may participate in P2P communication, such as with the first wireless communication device, the second wireless communication device, or both. Another AP, such as a root AP that allocates resources for wireless communication to other APs, may allocate the resources for the TXOP provided by the AP. The root AP, however, may not be aware of the QoS requirements of either of the first wireless communication device or the second wireless communication device participating in the P2P communication with the AP. Thus, when the shared TXOP is configured, one or more parameters of the TXOP may fail to satisfy the QoS requirement of the first wireless communication device, the QoS requirements of the second wireless communication device, or both, thereby negatively affecting communications efficiency.

In accordance with techniques described herein, for the root AP to allocate resources in accordance with QoS parameters associated with the P2P-participating first wireless communication device and/or the second wireless communication device (such as the end clients), which use the TXOP provided by an AP, the AP may relay information from the first wireless communication device and/or the second wireless communication device to the root AP. For example, the AP may forward a management request (such as a stream classification service (SCS) request) from the first wireless communication device to the root AP, where the management request may include an identifier (ID) of the first wireless communication device along with a stream ID (such as an SCS ID) selected by the AP for association with the first wireless communication device. The ID may indicate a request from a unassociated device (such as a device that is not associated with the root AP) or that the unassociated device is participating in a P2P communication. In some examples, the ID of the first wireless communication device may be a media access control (MAC) address of the first wireless communication device. In some examples, the techniques described herein may utilize a traffic identifier (TID) additionally, or alternatively to the SCS ID.

The AP may forward the SCS ID linked to the first wireless communication device, the identifier of the first wireless communication device as a modified management request to the root AP (such as a modified SCS request). In some examples, the AP may provide a management encapsulation frame that carries the SCS ID linked to the first wireless communication device and the identifier, to relay the modified management request from the first wireless communication device to the root AP. In this manner, the AP may serve as a relay between the first wireless device and the root AP, as the root AP may not be directly providing the TXOP to the first wireless communication device.

In some examples, the AP may transmit the modified management request to the root AP with a new ID (such as a compressed ID) that corresponds to the SCS ID of the first wireless communication device, the identifier of the first wireless communication device, or a combination of the SCS ID and identifier of the first wireless communication device. In such examples, the quantity of bits associated with the new ID may be fewer than the total quantity of bits associated with the SCS ID of the first wireless communication device and the identifier. In some examples, the AP may modify at least one parameter associated with the QoS parameters for the first wireless communication device, for example, based on a delay associated with receiving the SCS ID from the first wireless device and transmitting the modified request to the root AP. The AP may receive a multiple-user (MU) request-to-send (RTS) triggered transmission sharing (TXS) (such as a TXS trigger frame) that allocates resources for the TXOP sharing in accordance with the QoS parameters associated with the first wireless device, for example, based on receiving the modified management request. The AP may forward the MU RTS TXS trigger frame to one or both of the first wireless communication device or the second wireless communication device to enable the respective P2P communications with the AP, where the shared TXOP may be configured to satisfy the QoS requirements of one or both of the first wireless communication device or the second wireless communication device that are participating in the P2P communication with the AP.

In some examples, the root AP may send the MU RTS TXS to the AP, such that the AP (such as a co-located device of the AP) may use the TXOP and enable P2P communications between the AP (such as a soft AP) and other wireless communication device, such as the first wireless communication device and/or the second wireless communication device. For instance, the AP may support two or more functionalities, including, for example, STA functionality (such as a STA side of the soft AP) and AP functionality (such as an AP side of the soft AP) that may each operate or be associated with separate 802.11 protocol stacks. That is, the AP (such as respective co-located devices of the AP) may use different protocol stacks for communicating with the root AP and for communicating with the third wireless communication device. Here, the AP may use a first protocol stack for communicating with the root AP and a second protocol stack for communicating, via a co-located third wireless communication device, with the first wireless communication device, which uses the TXOP and facilitate the P2P communication between the AP and the first wireless communication device. As such, aspects of the AP functionality associated with the AP (such as the soft AP) may participate in P2P communication with another device (such as a STA) during at least a portion of the shared TXOP.

Particular aspects of the subject matter described in this disclosure can be implemented to realize one or more of the following potential advantages. In some examples, by providing the modified management request that includes the SCS ID identifying the first wireless communication device (such as the end client) and an indication of a P2P communication involving a unassociated wireless communication device (such as the first wireless communication device), the described techniques can be used to provide an MU-RTS TXOP in accordance with the QoS parameters of the first wireless device. Moreover, in some examples, by using the new ID instead of the SCS ID and the identifier of the first wireless device, the described techniques can be used to reduce overhead in the frame size of the request sent to the root AP, as well reduce the size of the MU-RTS TXOP received at the AP that includes the new ID. Thus, the described techniques may provide end client information (such as the first wireless device) or end communication (such as P2P communication) knowledge to the root AP to facilitate efficient resource allocation for TXOP grants in accordance with QoS information associated with the end client and end communication. The described techniques also may increase efficiency in providing the TXOP grant by reducing overhead when transmitting requests or receiving the MU-RTS TXOP for a TXOP grant procedure.

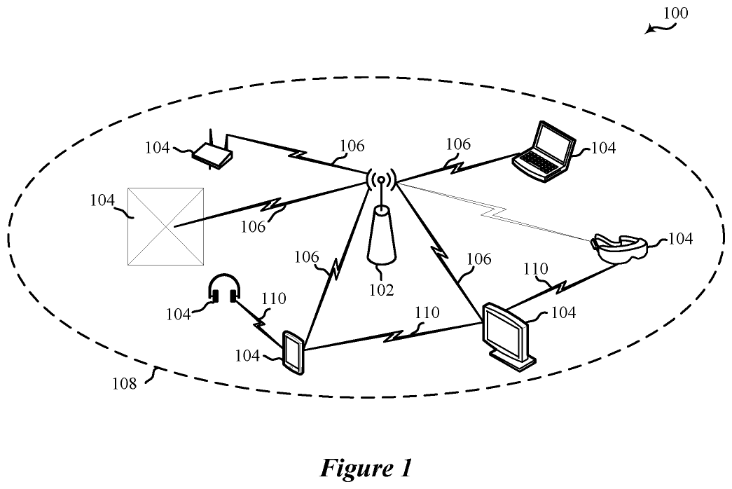

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHZ-24.25 GHZ), FR4a or FR4-1 (52.6 GHz-71 GHz), FR4 (52.6 GHz-114.25 GHZ), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

Puncturing is a wireless communication technique that enables a wireless communication device (such as an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as AP 102 or STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHZ, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various QoS parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

In some examples, a first STA 104, such as an XR device (a VR headset) may communicate with a second STA 104, such as another XR device, in a P2P communication. Also, in some examples, the AP 102 may provide the TXOP to wireless communication devices, such as the first STA 104 and/or the second STA 104, which may participate in the P2P communication with the AP. Another AP, such as a root AP 102 that allocates resources for wireless communication to other APs 102, may allocate the resources for the TXOP provided by the AP 102 for the P2P communication between the AP and the first STA 104 and/or the second STA 104.

The wireless communication network 100 may support the signaling of a management message (such as an SCS request, a management tunnel frame) that includes an identifier of a device that will be using a shared TXOP for P2P communications. For example, a first wireless communication device (such as a first STA 104) may send an SCS request to a second wireless communication device (such as a soft AP, a satellite AP, or other similar device). The second wireless communication device may forward the SCS request to an AP (such as a root AP), where the second wireless communication device may include an identifier of the first wireless communication device (such as a MAC address of the first wireless communication device). Further, the SCS request sent to the AP may include an ID selected by the second wireless communication device, where the ID may be used to associate, link, or otherwise enable correspondence between the SCS request sent from the second wireless communication device (to the root AP) and the SCS request received from the first wireless communication device (the first STA 104).

In some aspects, the second wireless communication device also may receive another SCS request from a third wireless communication device (such as a second STA 104) that will communicate with the second wireless communication device via a P2P link. In some implementations, the second wireless communication device may similarly forward the SCS request to the AP, including both an identifier of the third wireless communication device (such as a MAC address of the third wireless communication device) and an ID selected by the second wireless communication device (such as an SCS ID). The ID selected for the third wireless communication device may be unique to the third wireless communication device and may be different from the ID selected for the first wireless communication device, such that the ID selected for the third wireless communication device may tie, link, or otherwise enable a correspondence between an SCS request sent from the second wireless communication device to the AP and the SCS request received from the third wireless communication device.

The second wireless communication device may receive an MU RTS TXS trigger frame from the root AP, which may enable a shared TXOP. The second wireless communication device may, in turn, participate in P2P communications with the first wireless communications device during at least a portion of the shared TXOP. In such examples, aspects of an AP functionality of the second wireless communication device may participate in the P2P communications (e.g., as the second wireless communication device may be an example of a soft AP or other similar device). In some implementations, the parameters of the shared TXOP may be configured such that the QoS requirements of one or both of the first wireless communication device or the third wireless communication device may be met. More specifically, because the second wireless communication device provided an identifier of a respective device in the SCS request forwarded to the root AP, the TXOP may be configured in accordance with QoS parameters associated with the end wireless communication devices. Further, the ID selected by the second wireless communication device may enable the second wireless communication device to identify the device to which the shared TXOP (such as the TXOP indicated by the MU RTS TXS trigger) may be provided. Additionally, or alternatively, the second wireless communication device may modify one or more parameters of the TXOP, for example, to account for additional time needed to provide the indication of the shared TXOP to the first wireless communication device or to the third wireless communication device.

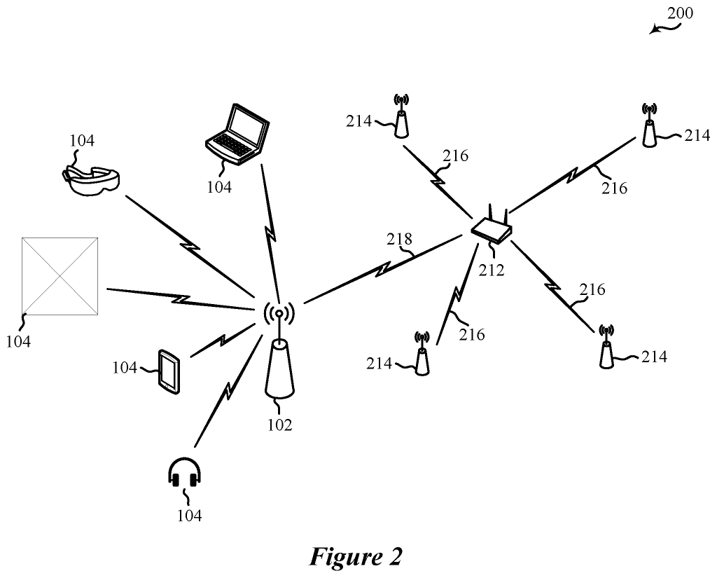

FIG. 2 shows a pictorial diagram of another example wireless communication network 200. According to some aspects, the wireless communication network 200 can be an example of a mesh network, an IoT network or a sensor network in accordance with one or more of the IEEE 802.11 family of wireless communication protocol standards (including the 802.11ah amendment). The wireless communication network 200 may include multiple wireless communication devices 214. The wireless communication devices 214 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (such as audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a Wi-Fi wireless communication network 100 or a wireless (such as cellular) wide area network (WWAN), which may, in turn, provide access to external networks including the Internet. For example, the intermediate device 212 may associate and communicate, over a Wi-Fi link 218, with an AP 102 of a WLAN network, which also may serve various STAs 204. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

In some examples, a first wireless communication device 214 may communicate with a third wireless communication device 214 via a P2P communication. An intermediate device 212 may provide a shared TXOP to one or both of the wireless communication devices 214, such as the first wireless communication device 214 and/or the third wireless communication device 214, that may participate in the P2P communication with the intermediate device 212. Another AP 102, such as a root AP that allocates resources for wireless communication for the shared TXOP, may allocate the resources for the TXOP provided by the AP 102 to the intermediate device 212 for P2P communications with the first wireless communication device 214 and/or the third wireless communication device 214.

The wireless communication network 200 may support the signaling of a management message (such as an SCS request, a management tunnel frame) that includes an identifier of a device that will be using a shared TXOP for P2P communications. For example, a first wireless communication device 214 (such as a first STA 104) may send an SCS request to an intermediate device 212 (such as a soft AP, a satellite AP, or other similar device). The intermediate device 212 may forward the SCS request to an AP 202 (such as a root AP), where the intermediate device 212 may include an identifier of the first wireless communication device 214 (such as a MAC address of the first wireless communication device 214). Further, the SCS request sent to the AP 202 may include an ID selected by the intermediate device 212, where the ID may be used to associate, link, or otherwise enable correspondence between the SCS request sent from the intermediate device 212 (to the root AP) and the SCS request received from the first wireless communication device 214 (the first STA 104).

In some aspects, the intermediate device 212 may receive another SCS request from a third wireless communication device 214 (such as a second STA 104) that may communicate with the first wireless communication device 214 or the intermediate device 212 via a P2P link. In such examples, the intermediate device 212 may similarly forward the SCS request to the AP, including both an identifier of the third wireless communication device 214 (such as a MAC address of the third wireless communication device 214) and an ID selected by the intermediate device 212 (such as an SCS ID). The ID selected for the third wireless communication device 214 may be unique to the third wireless communication device 214 and may be different from the ID selected for the first wireless communication device 214, such that the ID selected for the third wireless communication device 214 may tie, link, associate, or otherwise enable a correspondence between an SCS request sent from the intermediate device 212 to the AP and the SCS request received from the third wireless communication device 214 by the intermediate device 212.

The intermediate device 212 may receive an MU RTS TXS trigger frame from the root AP, which may enable a shared TXOP. The intermediate device 212 may, in turn, participate in P2P communications with the first wireless communications device 214 during at least a portion of the shared TXOP. In such examples, aspects of an AP functionality of the intermediate device 212 device may participate in the P2P communications (e.g., as the intermediate device 212 may be an example of a soft AP or other similar device). In such examples, the parameters of the shared TXOP may be configured such that the QoS requirements of one or both of the first wireless communication device 214 or the third wireless communication device 214 may be met. More specifically, because the intermediate device 212 provided an identifier of a respective device in the SCS request forwarded to the root AP, the TXOP may be configured in accordance with QoS parameters associated with that P2P-participating device. Further, the ID selected by the intermediate device 212 may enable the intermediate device 212 to identify the device to which the shared TXOP (such as the TXOP indicated by the MU RTS TXS trigger) may be provided. Additionally, or alternatively, the intermediate device 212 may modify one or more parameters of the TXOP, for example, to account for additional time needed to provide the indication of the shared TXOP to the first wireless communication device 214 or the third wireless communication device 214.

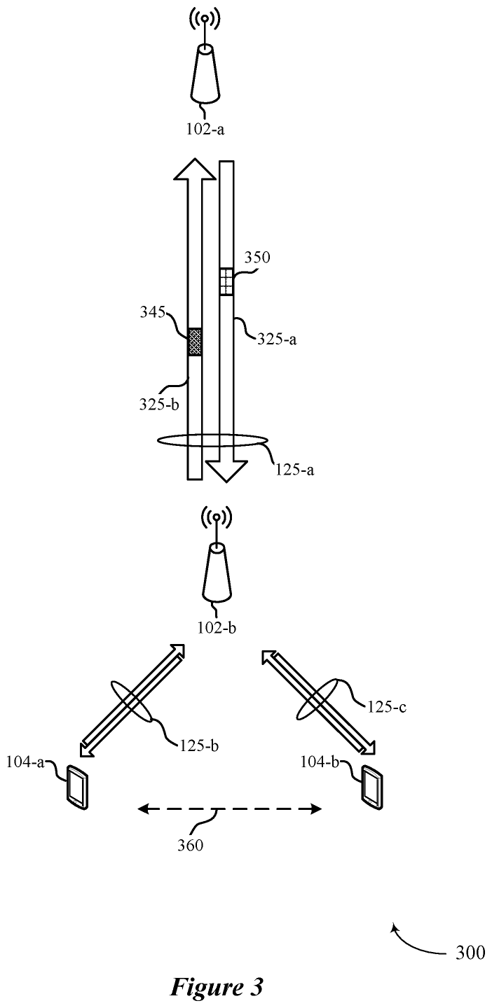

FIG. 3 shows an example of a signaling diagram 300 that supports QoS-based P2P TXOP grants. The signaling diagram 300 may implement aspects of or may be implemented by aspects of the wireless communication network 100. For example, the signaling diagram 300 includes an AP 102-a, an AP 102-b, an STA 104-a, and an STA 104-b, which may be examples of an AP 102 and an STA 104 described with respect to FIG. 1, respectively.

In the signaling diagram 300, the AP 102-a and the AP 102-b may communicate to perform the QoS-based P2P TXOP grants. The AP 102-a may communicate with the AP 102-b using a communication link 125-a. In some examples, the communication link 125 may include a first channel 325-a for transmitting data from the AP 102-a to the AP 102-b and a second channel 325-b for transmitting data from the AP 102-b to the AP 102-a.

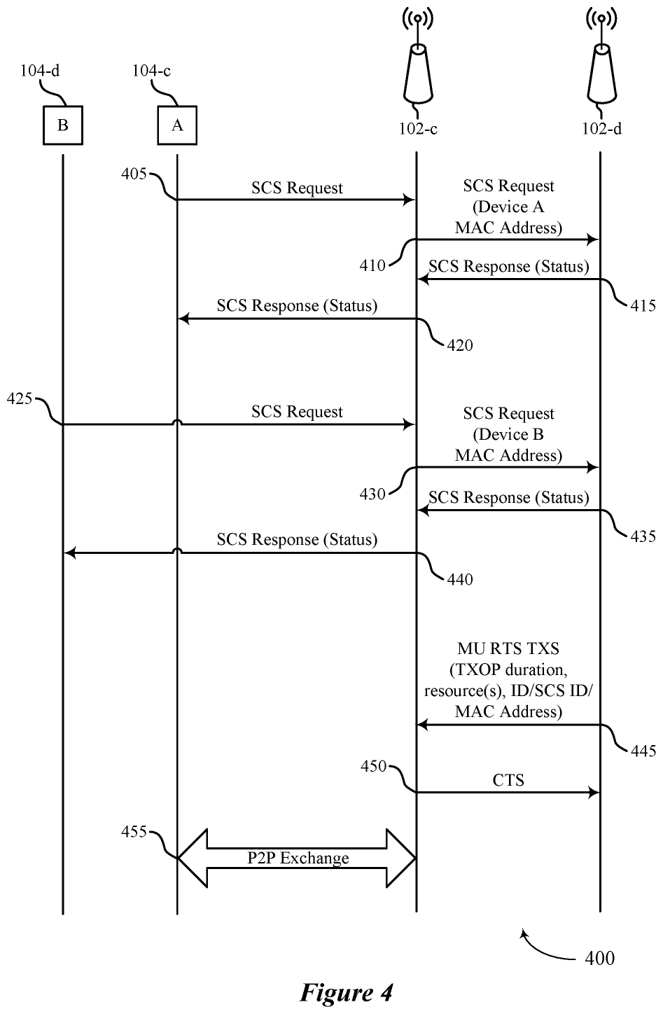

The communication link 125 may include a bi-directional link that enables both uplink and downlink communications, for example, via the channels 325. For example, the AP 102-b may transmit uplink messages 345 (such as uplink transmissions), such as uplink control signals or uplink data signals, to the AP 102-a using the second channel 325-b (such as of the communication link 125) and the AP 102-a may transmit downlink messages 350 (such as downlink transmissions), such as downlink control signals or downlink data signals, to the AP 102-b using the first channel 325-a (such as of the communication link 125). As discussed with respect to FIG. 4, the uplink messages 345 may include a message indicating a modified SCS request or a message indicating a clear to send message. As discussed with respect to FIG. 4, the downlink messages 350 may include a message indicating an SCS response or a message indicating an MU RTS TXS.

The AP 102-a may communicate with the STA 104-a using communication link 125-b and may communication with the STA 104-b using communication link 125-c. The communication link 125-b and the communication link 125-c may be operate as described with respect to the communication link 125-a. The communication link 125-b and the communication link 125-c may be P2P links for P2P wireless communications. The STAs 104 may transmit uplink messages to the AP 102-b indicating SCS requests and may receive downlink messages from the AP 102-b indicating SCS requests or an indication of P2P wireless communications. Additionally, the STA 104-a and the STA 104-b may communicate using a P2P communication link 360 or another sidelink communication link. For example, the AP 102-a may grant TXOP sharing to the AP 102-b, which may share TXOP with the STA 104-a, which may participate in P2P communication with the AP 102-b and/or the STA 104-b.

In some examples, P2P may be a feature considered for Wi-Fi and ultra-high reliability (UHR) communication systems, for example, by using APs 102 to control P2P devices. In some examples, for managing P2P, APs 102 may manage TXOP for sharing. TXOP sharing may allow an AP 102, such as AP 102-b, to share a TXOP with an associated client, such as STA 104-a, who is engaged in a P2P operation with the AP 102-b and/or another client, such as STA 104-b. In some examples, the AP 102-a, which allocates the TXOP and resources may not be aware of the P2P QOS requirements associated with the STA 104-a, the STA 104-b, or both, that participate in P2P wireless communications with the AP 102-b. For example, STA 104-a (such as Device A) and STA 104-b (such as Device B) may have different QoS requirements but the AP 102-b or the root AP 102-a may not know these QoS requirements. As discussed with respect to FIG. 3, the AP 102-a may grant TXOP to the AP 102-b (for sharing) in a QoS-based or QoS-aware manner. More specifically, the AP 102-b may include one or more identifiers associated with a STA 104 (such as the STA 104-a and/or the STA 104-b), which may enable a shared TXOP to be configured in accordance with the QoS requirements of one or more of the device to which the shared TXOP is to be provided. In some aspects, a management message sent from the AP 102-b to the AP 102-a may include a modified ID (such as a compressed ID) that represents a combination of a MAC address and an SCS ID of a corresponding STA 104, which may reduce a control frame size (such as a control frame that indicates the shared TXOP). In some aspects, an MU RTS TXS trigger frame may include an ID to identify an end SCS flow, which may include the compressed ID or may include an SCS ID and a MAC address of a corresponding device. Although the techniques described herein are discussed with respect to P2P communications, the techniques may apply to wireless mesh operations or other direct operations.

FIG. 4 shows an example of a process flow 400 that supports QoS-based P2P TXOP grants. The process flow 400 may implement aspects of or may be implemented by aspects of the wireless communication network 100. For example, the process flow 400 may include a AP 102-c, AP 102-d, STA 104-c, and STA 104-d, which may be examples of an AP 102 and an STA 104, respectively, as described herein. In the following description of the process flow 400, the operations performed by the AP 102-c, the AP 102-d, the STA 104-c, and the STA 104-d may be performed in different orders or at different times than the exemplary order shown. Some operations also may be omitted from the process flow 400, or other operations may be added to the process flow 400. Further, while operations in the process flow 400 are illustrated as being performed by the STAs 104 and the APs 102, the examples herein are not to be construed as limiting, as the described features may be associated with any quantity of different devices.

At 405, STA 104-c send an SCS request (such as a first management message) to the AP 102-c (such as a first wireless communication device), which may referred to as a soft-AP. The SCS request may include an SCS ID (such as a first stream identifier) that is associated with the STA 104-c (such as a second wireless communication device). At 410, the soft-AP 102-c may forward a modified SCS request (such as a second management message) to the AP 102-d, which may be referred to as a root AP. In particular, the soft AP 102-c may modify the SCS request obtained from clients, such as the STA 104-c, by adding the SCS ID of the STA 104-c, a client MAC address (such as an identifier associated with the STA 104-c) to the frame and forward the frame to the root AP 102-d.

In some examples, when the soft AP 102-c sends the modified SCS request to the root AP 102-d, the soft AP 102-c may pick a new SCS ID (such as a second stream identifier based on the first management message) that is different than the SCS ID selected by the STA 104-c. The soft AP 102-c may generate the New SCS ID such that the New SCS ID corresponds to the SCS ID of the STA 104-c, and a quantity of bits of the New SCS ID is smaller than a total quantity of bits of the SCS ID of the STA 104-c and the MAC address of the STA 104-c.

In some examples, both STA 104-c (such as Device A) and STA 104-d (Device B) may pick the same SCS ID, such as SCS ID=1, but the soft AP 102-c may select two different SCS IDs to indicate two distinct SCS sessions to the root AP 102-d. In some examples, the techniques described herein may use TIDs instead of SCS IDs. In some examples, the soft AP 102-c may form a new management tunnel frame in which the soft AP 102-c embeds the modified SCS request and sends it to the root AP 102-d.

At 415, the root AP 102-d may transmit an SCS response status to the soft AP 102-c including a status of the SCS request from the soft AP 102-c. At 420, the soft AP 102-c may provide the SCS response status to the STA 104-c (such as relay the message from the root AP 102-d). Similar process flow may occur at 425, 430, 435, and 440 for the STA 104-d as discussed with respect to 405, 410, 415, and 420 for the STA 104-c.

At 445, the soft AP 102-c may receive an MU RTS TXS (such as a first control message associated with a shared TXOP, indicating the shared TXOP associated with communication between the soft AP 102-c and the STA 104-c and/or the STA 104-d) from the root AP 102-d. The MU RTS TXS may include one or more parameters that satisfy a set of QoS parameters of the STA 104-c. When allocating the resources for P2P, the root AP 102-d may use a modified MU RTS TXS that includes the STA ID (such as the identifier of the STA 104-c) and the modified SCS ID (such as the second stream identifier) to the soft AP 102-c.

To reduce the size of MU RTS TXS, the soft AP 102-c may use the new ID that uniquely identifies the SCS ID for each of the connected STAs 104, and includes that new ID in the modified SCS request sent to the root AP 102-d. Accordingly, the MU RTS TXS may include the new ID. The soft AP 102-c may adjust the QoS parameters (such as reducing the delay bound) to account for any delay introduced by the multiple data flows, such as the SCS request from the STA 104-c to the soft AP 102-c and the modified SCS request from the soft AP 102-c to the root AP 102-d (such as an information hop from the soft AP 102-c to the root AP 102-d).

At 450, after receiving the MU RTS TXS, the soft AP 102-c may transmit a message indicating a clear to send, such that the soft AP 102-c is clear for receiving additional messages form the AP 102-d. In some examples, the MU RTS TXS enables the shared TXOP for AP 102-c and the STA 104-c and a third wireless communication device. This third wireless communication device that enables the TXOP sharing with the P2P-participating devices, such as the STA 104-c and/or the STA 104-c, may be co-located with the AP 102-c. That is, the third wireless communication device may be associated with or correspond to AP functionality of the AP 102-c, where the AP 102-c may support functions and/or operations that correspond to both STA functionality and AP functionality (such as the AP 102-c (a soft AP or similar device) may operate using a first protocol stack associated with communicating with the AP 102-d and a second protocol stack associated with communicating with the STA 104-c and/or the STA 104-d). In some examples, the soft AP 102-c may modify at least one parameter associated with the set of QoS parameters for the STA 104-c based on a delay associated with receiving the MU RTS TXS, where the one or more parameters of the MU RTS TXS are based at on modifying the at least one parameter. At 455, the soft AP 102-c may participate in a TXOP sharing with the STA 104-c for a P2P exchange associated with the AP 102-c and the STA 104-c.

In some examples, the modified SCS request may include the MAC address associated with the STA 104-c to identify the end client (or the STA 104-d when the end client is the STA 104-d). The modified SCS request may indicate that the request is for a P2P communication and/or for a unassociated client (for example, a client that is not associated with the root AP 102-d). In some examples, the modified SCS request may be a new management encapsulation frame to carry the modified SCS request frame from the STA 104-d (such as effectively as a tunnel communication passing through the soft AP 102-c). In some examples, the SCS request and the modified SCS request may be associated with a management encapsulation frame. The new ID may be used in place of the combination of the MAC address and the SCS ID of the STA 104-c, for example, to reduce the control frame size. In some examples, the new ID may use TID instead of the SCS ID. The new ID may be an SCS ID that is selected by the soft AP 102-c, and the selected SCS ID may be representative of the MAC address of the STA 104-c and SCS ID of the STA 104-c. In example, the soft AP 102-c may act as a proxy for the STA 104-c for the SCS ID. The modified MU RTS TXS may include an ID to identify end SCS flow, such as the combination of the MAC address and the SCS ID of the STA 104-c, or the new ID.

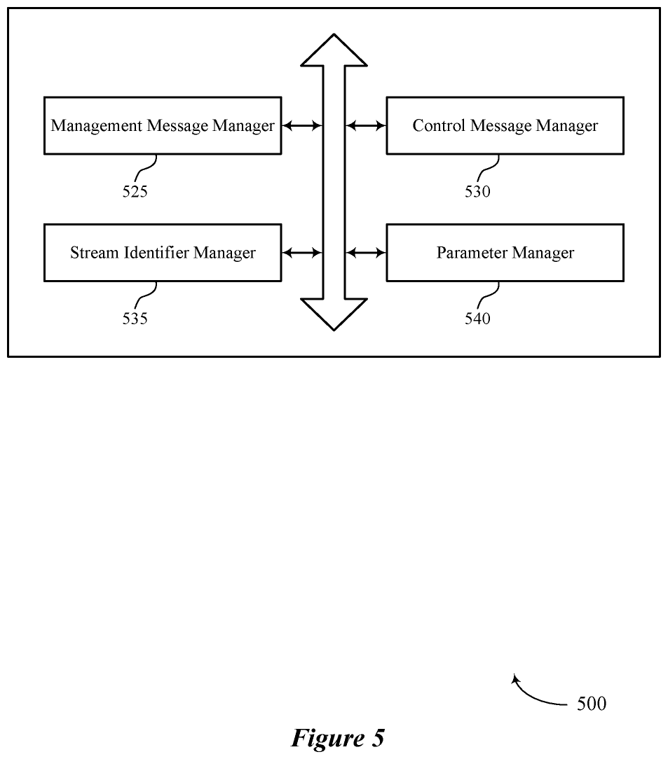

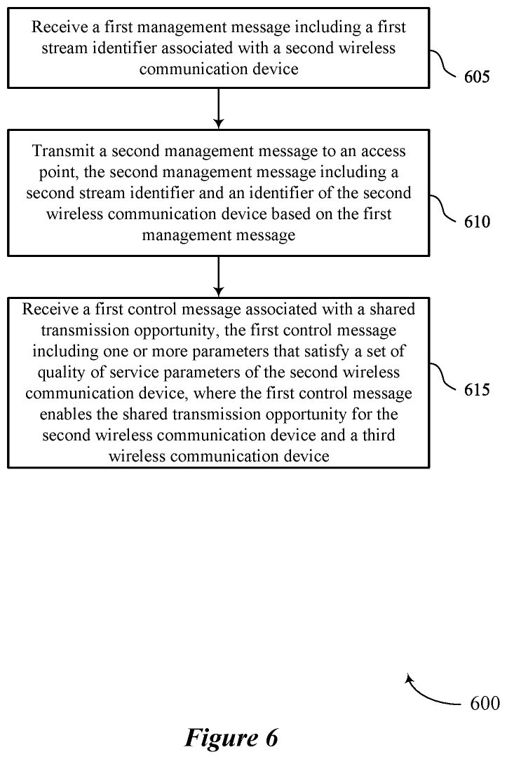

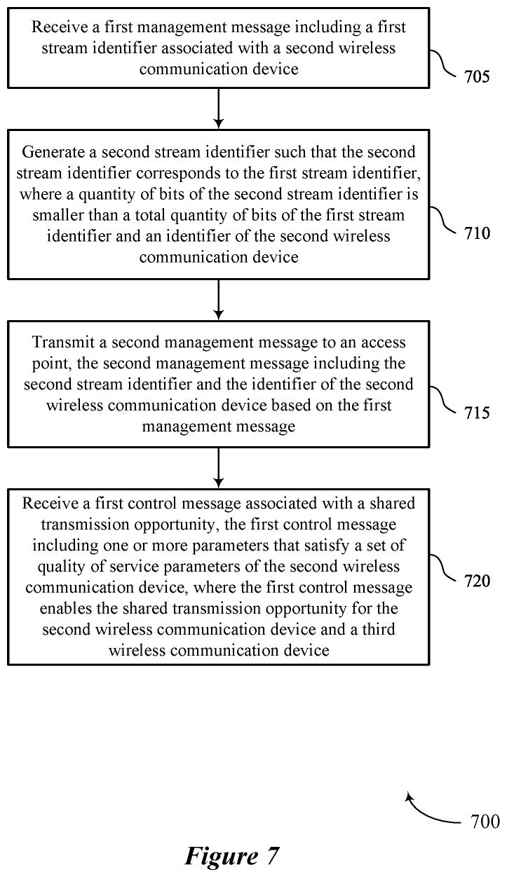

FIG. 5 shows a block diagram of an example wireless communication device 500 that supports QoS-based P2P TXOP grants. In some examples, the wireless communication device 500 is configured to perform the processes 600 and 700 described with reference to FIGS. 6 and 7, respectively. The wireless communication device 500 may include one or more chips, SoCs, chipsets, packages, components or devices that individually or collectively constitute or include a processing system. The processing system may interface with other components of the wireless communication device 500, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 500 may transmit the information output from the chip. In such an example, the second interface may refer to an interface between the processing system of the chip and a reception component, such that the wireless communication device 500 may receive information that is then passed to the processing system. In some such examples, the first interface also may obtain information, such as from the transmission component, and the second interface also may output information, such as to the reception component.

The processing system of the wireless communication device 500 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 500 can configurable or configured for use in an AP, such as the AP 102 described with reference to FIG. 1. In some other examples, the wireless communication device 500 can be an AP that includes such a processing system and other components including multiple antennas. The wireless communication device 500 is capable of transmitting and receiving wireless communications in the form of, for example, wireless packets. For example, the wireless communication device 500 can be configurable or configured to transmit and receive packets in the form of physical layer PPDUs and MPDUs conforming to one or more of the IEEE 802.11 family of wireless communication protocol standards. In some other examples, the wireless communication device 500 can be configurable or configured to transmit and receive signals and communications conforming to one or more 3GPP specifications including those for 5G NR or 6G. In some examples, the wireless communication device 500 also includes or can be coupled with one or more application processors which may be further coupled with one or more other memories. In some examples, the wireless communication device 500 further includes at least one external network interface coupled with the processing system that enables communication with a core network or backhaul network that enables the wireless communication device 500 to gain access to external networks including the Internet.

The wireless communication device 500 includes a management message manager 525, a control message manager 530, a stream identifier manager 535, and a parameter manager 540. Portions of one or more of the management message manager 525, the control message manager 530, the stream identifier manager 535, and the parameter manager 540 may be implemented at least in part in hardware or firmware. For example, one or more of the management message manager 525, the control message manager 530, the stream identifier manager 535, and the parameter manager 540 may be implemented at least in part by at least a processor or a modem. In some examples, portions of one or more of the management message manager 525, the control message manager 530, the stream identifier manager 535, and the parameter manager 540 may be implemented at least in part by a processor and software in the form of processor-executable code stored in memory.

The wireless communication device 500 may support wireless communication in accordance with examples as disclosed herein. The management message manager 525 is configurable or configured to receive a first management message including a first stream identifier associated with a second wireless communication device. In some examples, the management message manager 525 is configurable or configured to transmit a second management message to an AP, the second management message including a second stream identifier and an identifier of the second wireless communication device based on the first management message. The control message manager 530 is configurable or configured to receive a first control message associated with a shared TXOP, the first control message including one or more parameters that satisfy a set of QoS parameters of the second wireless communication device, where the first control message enables the shared transmission opportunity for the second wireless communication device and a third wireless communication device. In some examples, the third wireless communication device is co-located with the first wireless communication device.

In some examples, the stream identifier manager 535 is configurable or configured to generate the second stream identifier such that the second stream identifier corresponds to the first stream identifier, where a quantity of bits of the second stream identifier is smaller than a total quantity of bits of the first stream identifier and the identifier of the second wireless communication device. In some examples, the first control message include the second stream identifier.

In some examples, the parameter manager 540 is configurable or configured to modify at least one parameter associated with the set of QoS parameters for the second wireless communication device based on a delay associated with receiving the first control message, where the one or more parameters of the first control message are based on modifying the at least one parameter.

In some examples, the management message manager 525 is configurable or configured to receive a third management message including the first stream identifier associated with a fourth wireless communication device. In some examples, the stream identifier manager 535 is configurable or configured to determine a third stream identifier as an identifier for the fourth wireless communication device, where the first stream identifier is different than the third stream identifier. In some examples, the management message manager 525 is configurable or configured to transmit a fourth management message to the AP, the fourth management message including the third stream identifier and an identifier of the fourth wireless communication device. In some examples, the first management message and the second management message be associated with a management encapsulation frame.

In some examples, the first management message include a first stream classification service message. In some examples, the second management message include a second stream classification service (SCS) message. In some examples, the second stream identifier include a stream classification service (SCS) identifier. In some examples, the second stream identifier include a traffic identifier (TID).

In some examples, the share TXOP is associated with P2P communication between the first wireless communication device, second wireless communication device, the third wireless communication device, or any combination thereof.

FIG. 6 shows a flowchart illustrating an example process 600 performable by or at a first wireless communication device that supports QoS-based P2P TXOP grants. The operations of the process 600 may be implemented by a first wireless communication device or its components as described herein. For example, the process 600 may be performed by a wireless communication device, such as the wireless communication device 500 described with reference to FIG. 5, operating as or within a wireless AP. In some examples, the process 600 may be performed by a wireless AP, such as one of the APs 102 described with reference to FIG. 1.

In some examples, in block 605, the first wireless communication device may receive a first management message including a first stream identifier associated with a second wireless communication device. The operations of block 605 may be performed in accordance with examples as disclosed herein. In some implementations, aspects of the operations of block 605 may be performed by a management message manager 525 as described with reference to FIG. 5.

In some examples, in block 610, the first wireless communication device may transmit a second management message to an AP, the second management message including a second stream identifier and an identifier of the second wireless communication device based on the first management message. The operations of block 610 may be performed in accordance with examples as disclosed herein. In some implementations, aspects of the operations of block 610 may be performed by a management message manager 525 as described with reference to FIG. 5.

In some examples, in block 615, the first wireless communication device may receive a first control message associated with a shared TXOP, the first control message including one or more parameters that satisfy a set of QoS parameters of the second wireless communication device, where the first control message enables the shared transmission opportunity for the second wireless communication device and a third wireless communication device. The operations of block 615 may be performed in accordance with examples as disclosed herein. In some implementations, aspects of the operations of block 615 may be performed by a control message manager 530 as described with reference to FIG. 5.

FIG. 7 shows a flowchart illustrating an example process 700 performable by or at a first wireless communication device that supports QoS-based P2P TXOP grants. The operations of the process 700 may be implemented by a first wireless communication device or its components as described herein. For example, the process 700 may be performed by a wireless communication device, such as the wireless communication device 500 described with reference to FIG. 5, operating as or within a wireless AP. In some examples, the process 700 may be performed by a wireless AP, such as one of the APs 102 described with reference to FIG. 1.

In some examples, in block 705, the first wireless communication device may receive a first management message including a first stream identifier associated with a second wireless communication device. The operations of block 705 may be performed in accordance with examples as disclosed herein. In some implementations, aspects of the operations of block 705 may be performed by a management message manager 525 as described with reference to FIG. 5.

In some examples, in block 710, the first wireless communication device may generate the second stream identifier such that the second stream identifier corresponds to the first stream identifier, where a quantity of bits of the second stream identifier is smaller than a total quantity of bits of the first stream identifier and the identifier of the second wireless communication device. The operations of block 710 may be performed in accordance with examples as disclosed herein. In some implementations, aspects of the operations of block 710 may be performed by a stream identifier manager 535 as described with reference to FIG. 5.

In some examples, in block 715, the first wireless communication device may transmit a second management message to an AP, the second management message including a second stream identifier and an identifier of the second wireless communication device based on the first management message. The operations of block 715 may be performed in accordance with examples as disclosed herein. In some implementations, aspects of the operations of block 715 may be performed by a management message manager 525 as described with reference to FIG. 5.

In some examples, in block 720, the first wireless communication device may receive a first control message associated with a shared TXOP, the first control message including one or more parameters that satisfy a set of QoS parameters of the second wireless communication device, where the first control message enables the shared transmission opportunity for the second wireless communication device and a third wireless communication device. The operations of block 720 may be performed in accordance with examples as disclosed herein. In some implementations, aspects of the operations of block 720 may be performed by a control message manager 530 as described with reference to FIG. 5.

Implementation examples are described in the following numbered clauses: The following provides an overview of aspects of the present disclosure:

Aspect 1: A method for wireless communication at a first wireless communication device, comprising: receiving a first management message comprising a first stream identifier associated with a second wireless communication device; transmitting a second management message to an access point, the second management message comprising a second stream identifier and an identifier of the second wireless communication device based at least in part on the first management message; and receiving a first control message associated with a shared TXOP, the first control message comprising one or more parameters that satisfy a set of quality of service parameters of the second wireless communication device, where the first control message enables the shared TXOP for the second wireless communication device and a third wireless communication device.

Aspect 2: The method of aspect 1, where the third wireless communication device is co-located with the first wireless communication device.

Aspect 3: The method of any of aspects 1 through 2, further comprising: generating the second stream identifier such that the second stream identifier corresponds to the first stream identifier, where a quantity of bits of the second stream identifier is smaller than a total quantity of bits of the first stream identifier and the identifier of the second wireless communication device.

Aspect 4: The method of aspect 3, where the first control message comprises the second stream identifier.

Aspect 5: The method of any of aspects 1 through 4, further comprising: modifying at least one parameter associated with the set of quality of service parameters for the second wireless communication device based at least in part on a delay associated with receiving the first control message, where the one or more parameters of the first control message are based at least in part on modifying the at least one parameter.

Aspect 6: The method of any of aspects 1 through 5, further comprising: receiving a third management message comprising the first stream identifier associated with a fourth wireless communication device; determining a third stream identifier as an identifier for the fourth wireless communication device, where the first stream identifier is different than the third stream identifier; and transmitting a fourth management message to the access point, the fourth management message comprising the third stream identifier and an identifier of the fourth wireless communication device.

Aspect 7: The method of any of aspects 1 through 6, where the first management message and the second management message are associated with a management encapsulation frame.

Aspect 8: The method of any of aspects 1 through 7, where the first management message comprises a first stream classification service message, and the second management message comprise a second SCS message.

Aspect 9: The method of any of aspects 1 through 8, where the second stream identifier comprises a SCS identifier.

Aspect 10: The method of any of aspects 1 through 9, where the second stream identifier comprises a TID.

Aspect 11: A first wireless communication device for wireless communication, comprising one or more memories storing processor-executable code, and one or more processors coupled with the one or more memories and individually or collectively operable to execute the code to cause the first wireless communication device to perform a method of any of aspects 1 through 10.

Aspect 12: A first wireless communication device for wireless communication, comprising at least one means for performing a method of any of aspects 1 through 10.

Aspect 13: A non-transitory computer-readable medium storing code for wireless communication, the code comprising instructions executable by one or more processors to perform a method of any of aspects 1 through 10.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
one or more memories storing processor-executable code; and
one or more processors communicatively coupled with the one or more memories and individually or collectively configured to, when executing the code, cause first wireless communication device to:
receive a first management message comprising a first stream identifier associated with a second wireless communication device;
transmit a second management message to an access point, the second management message comprising a second stream identifier and an identifier of the second wireless communication device based at least in part on the first management message; and
receive a first control message associated with a shared transmission opportunity, the first control message comprising one or more parameters that satisfy a set of quality of service parameters of the second wireless communication device, wherein the first control message enables the shared transmission opportunity for the second wireless communication device and a third wireless communication device.

2. The first wireless communication device of claim 1, wherein the third wireless communication device is co-located with the first wireless communication device.

3. The first wireless communication device of claim 1, wherein the one or more processors are individually or collectively further configured to cause the first wireless communication device to:
generate the second stream identifier such that the second stream identifier corresponds to the first stream identifier, wherein a quantity of bits of the second stream identifier is smaller than a total quantity of bits of the first stream identifier and the identifier of the second wireless communication device.

4. The first wireless communication device of claim 3, wherein the first control message comprises the second stream identifier.

5. The first wireless communication device of claim 1, wherein the one or more processors are individually or collectively further configured to cause the first wireless communication device to:
modify at least one parameter associated with the set of quality of service parameters for the second wireless communication device based at least in part on a delay associated with receiving the first control message, wherein the one or more parameters of the first control message are based at least in part on modifying the at least one parameter.

6. The first wireless communication device of claim 1, wherein the one or more processors are individually or collectively further configured to cause the first wireless communication device to:
receive a third management message comprising the first stream identifier associated with a fourth third wireless communication device;
determine a third stream identifier as an identifier for the fourth wireless communication device, wherein the first stream identifier is different than the third stream identifier; and
transmit a fourth management message to the access point, the fourth management message comprising the third stream identifier and an identifier of the fourth wireless communication device.

7. The first wireless communication device of claim 1, wherein the first management message and the second management message are associated with a management encapsulation frame.

8. The first wireless communication device of claim 1, wherein:
the first management message comprises a first stream classification service message, and
the second management message comprise a second stream classification service (SCS) message.

9. The first wireless communication device of claim 1, wherein the second stream identifier comprises a stream classification service (SCS) identifier.

10. The first wireless communication device of claim 1, wherein the second stream identifier comprises a traffic identifier (TID).

11. The first wireless communication device of claim 1, wherein the shared transmission opportunity is associated with peer-to-peer communication between the first wireless communication device, the second wireless communication device, the third wireless communication device, or any combination thereof.

12. A method for wireless communication at a first wireless communication device, comprising:
receiving a first management message comprising a first stream identifier associated with a second wireless communication device;
transmitting a second management message to an access point, the second management message comprising a second stream identifier and an identifier of the second wireless communication device based at least in part on the first management message; and
receiving a first control message associated with a shared transmission opportunity, the first control message comprising one or more parameters that satisfy a set of quality of service parameters of the second wireless communication device, wherein the first control message enables the shared transmission opportunity for the second wireless communication device and a third wireless communication device.

13. The method of claim 12, wherein the third wireless communication device is co-located with the first wireless communication device.

14. The method of claim 12, further comprising:
generating the second stream identifier such that the second stream identifier corresponds to the first stream identifier, wherein a quantity of bits of the second stream identifier is smaller than a total quantity of bits of the first stream identifier and the identifier of the second wireless communication device.

15. The method of claim 14, wherein the first control message comprises the second stream identifier.

16. The method of claim 12, further comprising:
modifying at least one parameter associated with the set of quality of service parameters for the second wireless communication device based at least in part on a delay associated with receiving the first control message, wherein the one or more parameters of the first control message are based at least in part on modifying the at least one parameter.

17. The method of claim 12, further comprising:
receiving a third management message comprising the first stream identifier associated with a fourth wireless communication device;
determining a third stream identifier as an identifier for the fourth wireless communication device, wherein the first stream identifier is different than the third stream identifier; and
transmitting a fourth management message to the access point, the fourth management message comprising the third stream identifier and an identifier of the fourth wireless communication device.

18. The method of claim 12, wherein the first management message and the second management message are associated with a management encapsulation frame.

19. The method of claim 12, wherein:
the first management message comprises a first stream classification service message, and
the second management message comprise a second stream classification service (SCS) message.

20. The method of claim 12, wherein the second stream identifier comprises a stream classification service (SCS) identifier.

21. The method of claim 12, wherein the second stream identifier comprises a traffic identifier (TID).

22. A first wireless communication device for wireless communication, comprising:
processing circuitry associated with one or more memory devices and configured to cause the first wireless communication device to:
receive a first management message comprising a first stream identifier associated with a second wireless communication device;
transmit a second management message to an access point, the second management message comprising a second stream identifier and an identifier of the second wireless communication device based at least in part on the first management message; and
receive a first control message associated with a shared transmission opportunity, the first control message comprising one or more parameters that satisfy a set of quality of service parameters of the second wireless communication device, wherein the first control message enables the shared transmission opportunity for the second wireless communication device and a third wireless communication device.

23. The first wireless communication device of claim 22, wherein the third wireless communication device is co-located with the first wireless communication device.

24. The first wireless communication device of claim 22, wherein the processing circuitry is further configured to cause the first wireless communication device to:
generate the second stream identifier such that the second stream identifier corresponds to the first stream identifier, wherein a quantity of bits of the second stream identifier is smaller than a total quantity of bits of the first stream identifier and the identifier of the second wireless communication device.

25. The first wireless communication device of claim 24, wherein the first control message comprises the second stream identifier.

26. The first wireless communication device of claim 22, wherein the processing circuitry is further configured to cause the first wireless communication device to:
modify at least one parameter associated with the set of quality of service parameters for the second wireless communication device based at least in part on a delay associated with receiving the first control message, wherein the one or more parameters of the first control message are based at least in part on modifying the at least one parameter.

27. The first wireless communication device of claim 22, wherein the processing circuitry is further configured to cause the first wireless communication device to:
receive a third management message comprising the first stream identifier associated with a fourth wireless communication device;
determine a third stream identifier as an identifier for the fourth wireless communication device, wherein the first stream identifier is different than the third stream identifier; and
transmit a fourth management message to the access point, the fourth management message comprising the third stream identifier and an identifier of the fourth wireless communication device.

28. The first wireless communication device of claim 22, wherein the first management message and the second management message are associated with a management encapsulation frame.

29. The first wireless communication device of claim 22, wherein:
the first management message comprises a first stream classification service message, and
the second management message comprise a second stream classification service (SCS) message.

30. A first wireless communication device for wireless communication, comprising:
means for receiving a first management message comprising a first stream identifier associated with a second wireless communication device;
means for transmitting a second management message to an access point, the second management message comprising a second stream identifier and an identifier of the second wireless communication device based at least in part on the first management message; and
means for receiving a first control message associated with a shared transmission opportunity, the first control message comprising one or more parameters that satisfy a set of quality of service parameters of the second wireless communication device, wherein the first control message enables the shared transmission opportunity for the second wireless communication device and a third wireless communication device.
